(19) United States
(12) Patent Application Publication
(10) Pub. No.: US 2008/0071589 A1
(43) Pub. Date: Mar. 20, 2008

(54) Evaluating Development of Enterprise Computing System

(75) Inventor: Karolin Laicher, Rauenberg (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/464,371

(22) Filed: Aug. 14, 2006

(51) Int. Cl. G06F 9/44

(52) U.S. Cl. 705/7

(57) ABSTRACT

A method of evaluating development of an enterprise computing system includes receiving, in a computer system, a definition of a target characteristic configured to be used in performing a return on investment analysis of an enterprise computing system. During development of the enterprise computing system, at least a predefined portion of the enterprise computing system is evaluated using the target characteristic. The method further includes outputting from the computer system feedback information on the development including a result of the evaluation.

### TECHNICAL FIELD

The description relates to development-stage evaluation of a computer system.

### BACKGROUND

Today, the decision of choosing a computer system among the available solutions, such as systems for enterprise resource planning, is often driven by two major questions: “What value does a certain solution have to our organization”? and “What must we invest to get that value?”.

The answer to these questions depends on a myriad of solution characteristics. On the business value side, such characteristics include: How long does it take to deploy the solution, what is the value of it afterwards and how does one sustain this value? On the cost side, key characteristics are: What investments in hard- and software, implementation, operations and possibly further improvements of the solution must be made?

The solution value for the customer is mainly based on the following metrics: How long does it take to recoup the costs of the solution; what return does a customer get from the investment on a yearly base; and what net present value does the investment have. In other words, the purchase decision for the customer is driven by a return-on-investment (ROI) analysis, and the outcome of the ROI analysis is therefore critically important to the system manufacturer.

### SUMMARY

The invention relates to performing aspects of an ROI analysis in a development phase. In general, the development of an enterprise computing system is shown to receive feedback based on evaluating a target characteristic from an ROI analysis. For example, the evaluation can show whether the development is on track towards creating an enterprise computing system that meets an expected ROI standard.

In a first general aspect, a method of evaluating development of an enterprise computing system includes receiving, in a computer system, a definition of a target characteristic configured to be used in performing a return on investment analysis of an enterprise computing system. During development of the enterprise computing system, at least a predefined portion of the enterprise computing system is evaluated using the target characteristic. The method further includes outputting from the computer system feedback information on the development including a result of the evaluation.

Implementations may include any or all of the following features. The target characteristic may be defined as a desirable value for a predefined aspect of the enterprise computing system. The target characteristic may include a target value associated with a key performance indicator, and the enterprise computing system is to be developed such that it meets the target value upon the key performance indicator being evaluated. At least one of the key performance indicator and the target value may be defined based on market information. The method may further include identifying several processes included in installing and using the enterprise computing system, and analyzing the several processes to identify at least the key performance indicator. The key performance indicator may be at least one selected from the group consisting of: a required hardware investment, a required system compatibility, an average traffic volume, a required software investment, a time required for installation, a time required for technical configuration, a time required for installation training, a time required for implementation, an effort required for implementation, a skill set required for implementation, a number of employees needed for the enterprise computing system, a time required for training, an amount of downtime, an amount of work needed for an improvement or upgrade, an amount of training needed for an improvement or upgrade, an amount of downtime needed for an improvement or upgrade, an amount of work needed to detect a need for an improvement or upgrade, a time required to make an improvement or upgrade, an effort required to make an improvement or upgrade, a skill set required to make an improvement or upgrade, a standard compliance, a user efficiency, a user satisfaction, a user ease of learning, a number of solutions available for a specific problem, a number of modifications available, a test coverage, an error rate, and combinations thereof. Several target characteristics may be received, the several target characteristics being organized in a value of solution framework that provides a basis for the return on investment analysis. The value of solution framework may be configured for a total cost of ownership analysis to be performed based on at least one of the several target characteristics. Several evaluations of the predefined portion of the enterprise computing system may be performed over time during the development, and feedback information may be output for each of the evaluations. The predefined portion of the enterprise computing system that is evaluated may be a prototype. The predefined portion of the enterprise computing system that is evaluated may be a test case. The predefined portion of the enterprise computing system that is evaluated may be a definition of a use case. The predefined portion of the enterprise computing system that is evaluated may be a guideline for the enterprise computing system. The result of the evaluation may state whether the predefined portion of the enterprise computing system meets the target characteristic. The result of the evaluation may indicate a degree to which the predefined portion of the enterprise computing system conforms with the target characteristic. The method may further include receiving a revised definition of the target characteristic; substituting the revised definition for the definition that was received earlier; evaluating the predefined portion of the enterprise computing system during the development using the revised definition of the target characteristic; and outputting from the computer system feedback information on the development including a result of the evaluation that uses the revised definition. The method may further include storing at least a portion of the feedback information and later using the stored portion in development of another enterprise computing system. Several target characteristics may be used, and the stored portion of the feedback information may be structured according to a corresponding one of the several target characteristics.

In a second general aspect, a computer program product is tangibly embodied in an information carrier and includes instructions that, when executed, cause a processor to perform operations including receiving, in a computer system, several definitions of key performance indicators and corresponding target values. The key performance indicators and the target values are configured to be used in performing, for an enterprise computing system, a return on investment analysis that includes a total cost of ownership analysis. During development of the enterprise computing system, evaluations of the enterprise computing system are performed using the key performance indicators and the target values. The operations further include outputting from the computer system feedback information on the development including results of the evaluations.

Implementations may include any or all of the following features. The feedback information may indicate a degree to which the enterprise computing system conforms, at a point when the evaluations are performed, with the target values of the key performance indicators. The operations may further include: receiving a revised definition of at least one of the key performance indicators or corresponding target values; substituting the revised definition for the definition that was received earlier; evaluating at least a portion of the enterprise computing system during the development using the revised definition; and outputting from the computer system feedback information on the development including a result of the evaluation that uses the revised definition.

The systems and methods described herein may provide any or all of these advantages. Providing a capturing at an early stage of the most relevant product attributes. Providing a useful definition of their respective target values to derive market requirements therefrom. Continuously tracking and observing a degree of maturity and correctness with regard to the attributes and targets.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a block diagram of a general procedural model.

FIG. 2 shows a block diagram showing a value of solution framework.

FIG. 3 shows a flow chart of an execution of a method.

FIG. 4 shows a block diagram of a general computer system.

Like reference numerals in the various drawings indicate like elements.

### DETAILED DESCRIPTION

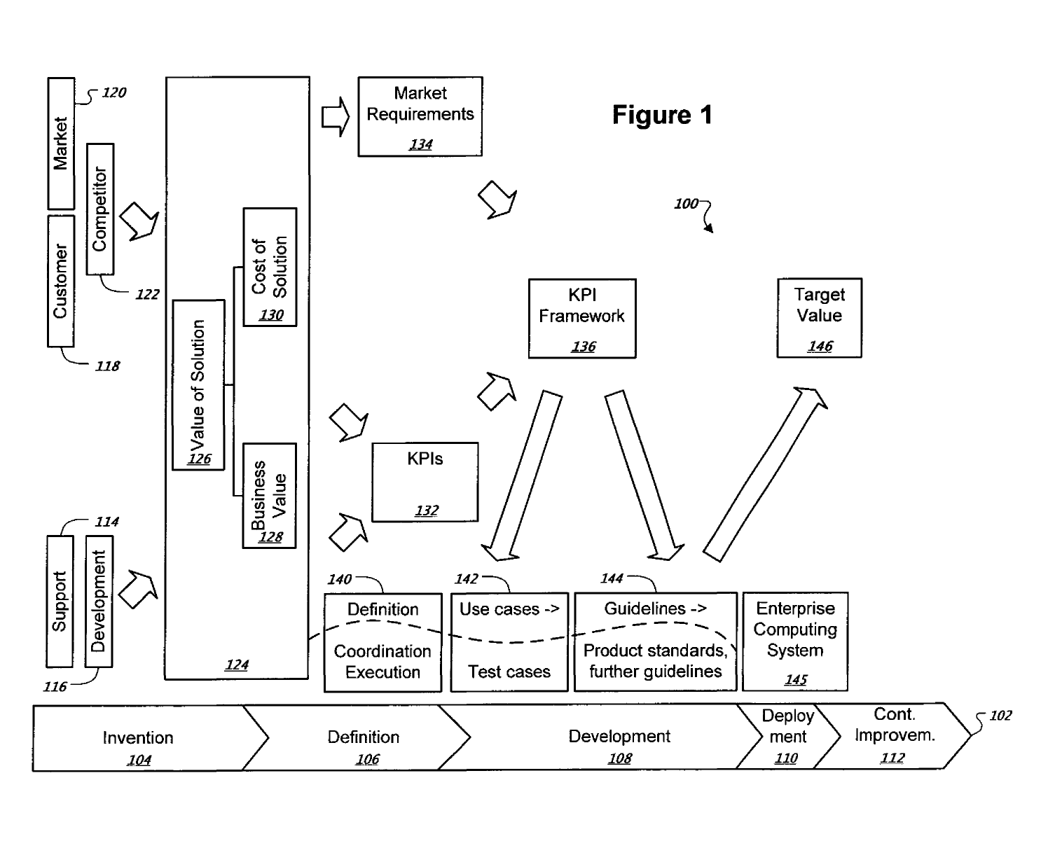

FIG. 1 is a block diagram of a procedural model I 00 that represents an implementation of a method of evaluating development of an enterprise computing system. The evaluation uses a definition of a target characteristic that is also configured to be used, when the enterprise computing system is in operation, in performing a return on investment (ROI) analysis of the enterprise computing system. When the method is finished executing the evaluation, feedback is returned to the user and can be output for viewing to a screen, or can be fed into a component that manages the development, for example a scheduling module. The method can be executed during any or all phases in the life-cycle of an enterprise computing system's development to evaluate the phase(s). Because the ROI evaluation is performed during development, it gives an early indication of how the finished system will conform to such requirements. Once the system has been developed, there is a level of assurance that it will conform with the customer requirements.

A development life-cycle, as here schematically indicated by development life-cycle phases 102, can schematically be divided into an invention phase 104, a definition phase 106, a development phase 108, a deployment phase 110, and a continuous improvement phase 112. The invention phase 104 is an initial phase of accumulating information relevant to the system that is to be developed. In some implementations, the invention phase 104 includes steps to gather the information for defining the target characteristics for the enterprise computing system. Target characteristics can be received from any or all of a support staff 114, a development staff 116, a customer 1 8, market information 120, or a competitor 122 with an enterprise computing system. For example, the development staff can generate a target characteristic in the form of a system requirement or system guideline which can state that the enterprise system shall implement a specific activity or function. As another example, customers provide input on what features or characteristics they expect or demand from the system.

In some implementations, target characteristics define a desirable value for a predefined aspect of the enterprise computing system. For example, a target characteristic can define the maintenance cost such that a desirable value is less than a predetermined amount.

In some implementations, target characteristics can include a target value associated with a corresponding key performance indicator (KPI). The KPI is configured for use in evaluating the system during use. The evaluation will then indicate whether the system meets the target value for the KPI. KPIs can include, but are not limited to, the following:

Exemplary KPIs:

A required hardware investment
A required system compatibility
An average traffic volume
A required software investment
A time required for installation
A time required for technical configuration
A time required for installation training
A time required for implementation
An effort required for implementation
A skill set required for implementation
A number of employees need for the enterprise computing system
A time required for training
An amount of downtime
An amount of work needed for an improvement or upgrade
An amount of training needed for an improvement or upgrade
An amount of downtime needed for an improvement or upgrade
An amount of work needed to detect a need for an improvement or upgrade
A time required to make an improvement or upgrade
An effort required to make an improvement or upgrade
A skill set required to make an improvement or upgrade
A standard compliance
A user efficiency
A user satisfaction
A user ease of learning
A number of solutions available for a specific problem
A number of modifications available
A test coverage
An error rate

Combinations of any of the above exemplary KPIs may be used. For each of the KPIs, a corresponding target value can be defined and used as described herein.

The definition phase 106 is a period of more specific planning, focusing and decision-making regarding the system to be developed. In some implementations, the definition phase 106 includes obtaining the target values and KPIs from a value of solution framework 124. The target values can be a set of target characteristics or KPIs intended to be measured by the execution of the method. The framework 124, in turn, shows how the value of the solution depends on conformity or non-conformity with the target values.

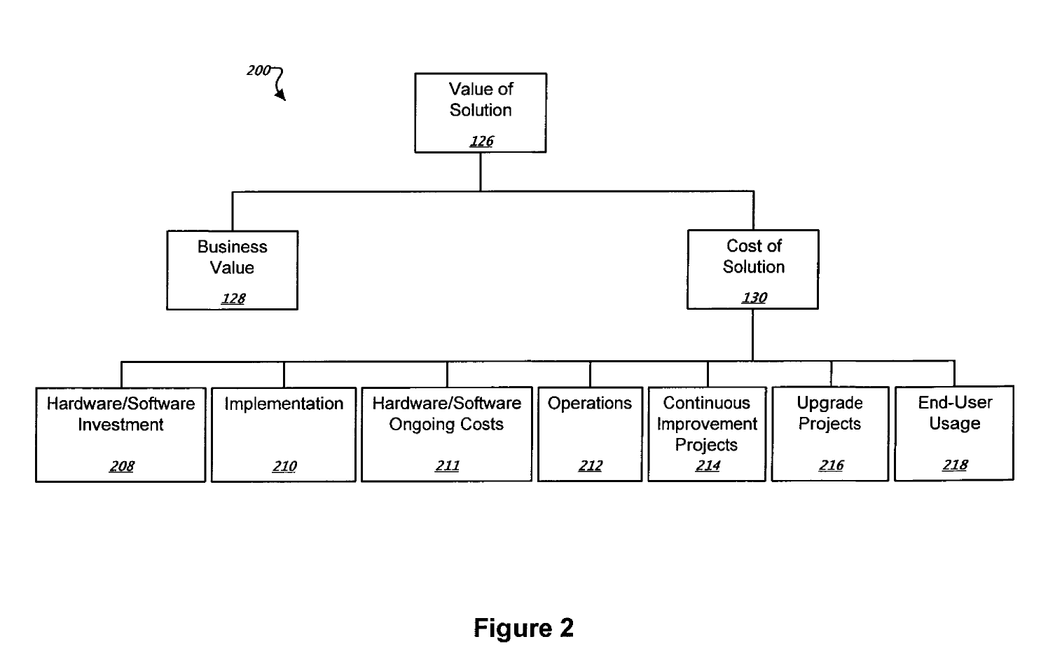

The value of solution framework 124 can include a value of solution, as indicated by block 126. The value of solution represents the value that the system has to the customer, and may include complex factors that do not directly correspond to a dollar amount. From a business standpoint, the value of solution 126 is the positive value that motivates the customer to buy the system. Here, the value of solution framework is defined as a difference between a business value, as shown by block 128 and a cost of solution, as indicated by block 130. The cost of solution 130 may correspond to a total cost of ownership (TCO) analysis. For example, it can be contemplated that the implementation of the system will be associated with signification costs at first, while the business value increase over time, thus resulting in the positive value of solution. The value of solution framework is described in more detail below, with reference to FIG. 2.

KPIs, as indicated by block 132, can be used in conjunction with a set of market requirements for the cost of solution, as indicated by block 134, to generate a KPI Framework, as indicated by block 136. The KPI Framework forms an overall definition of the requirements and guidelines that should be applied to the enterprise computing system and has been formulated with the TSV framework 124 in mind. In some implementations, the set of market requirements can be derived from the cost of solution in the value of solution framework. The KPIs can be derived from the business value and the cost of solution. The KPI Framework can be used to evaluate the development project and provide feedback regarding a degree of maturity of the defined enterprise computing system being developed.

The KPI Framework 136 can be revised based on market trends. For example, if a target characteristic defines an installation footprint size, the installation size could change overtime because the market trend specifying the computer for installation has changed such that a different computer, with different storage capabilities, is instead required. In some implementations, the definition phase can also include a process, indicated by block 140, whereby the definition and coordination of the enterprise computing system are evaluated using the target values and KPIs.

The development phase 108 is a period of engineering and system generation. In some implementations, the development phase 108 can include development tasks such as code writing and unit testing. Development tasks can be carried out by the development staff 116. The development phase can also include executing the method and measuring the results with the KPI Framework 136. This can be accomplished using a use case or a test case, as indicated by block 142 and by using a guideline, a product standard or a further guideline, as indicated by block 144. A use case can define a set of activities that the enterprise computing system must execute in order to implement a function. For example, in an order processing use case, the order function can be implemented by executing an inventory activity, a pricing activity, a part reservation activity, and a monetary collection activity. A test case can define a set of conditions that must be met such that the activities of the function are executed successfully by the enterprise computing system. For example, a test case can be generated to ensure that when an item is out of stock, the inventory activity will generate a proper error message. Use cases can be used to derive test cases, or test cases can be derived independently of use cases, to name two examples. Evaluation of the guidelines may involve determining their size or the skill level needed to use them, for example.

During the development life-cycle 102 of the enterprise computing system, the method can evaluate at least a predefined portion of the enterprise computing system using the target characteristic, and output the feedback information on the development including a result of the evaluation. The result of evaluation states whether the predefined portion of the enterprise computing system meets the target characteristic or states the degree to which the predefined portion of the enterprise computing system conforms to the target characteristic, to name two examples. The development process can then be changed in response to the feedback information returned by the evaluation. For example, if the evaluation states that the enterprise computing system is exceeding its installation footprint size, steps such as data compression can be taken to reduce the enterprise computing system's installation footprint size. The predefined portion of the enterprise computer system can include, but is not limited to, any combination of prototypes, test cases, use cases, and enterprise computing system guidelines.

During the deployment phase 110, the customer 1 18 takes delivery of enterprise computing system 145. Because the system has been evaluated against the KPIs and the target values during development, and assuming that necessary changes were made to ensure compliance with the target values, it can be expected that the finished system 145 will satisfy the specified target values 146.

The continuous improvement phase 112 is a period of on-going system validation. In some implementations, during the continuous improvement phase 112, the enterprise computing system can be modified in an attempt to meet a target characteristic or KPI that did not satisfy the predetermined threshold during the development phase 108 or the deployment phase 110. Modifications to the enterprise computer system can include, but are not limited to, software usability enhancements, software quality enhancements, process improvements, improved documentation, and improved training materials. The method can continually measure the specified target values, as indicated by block 146, of the enterprise computing system during the continuous improvement phase to determine if each target characteristic or KPI is within the predetermined threshold. For any that are not, efforts can be made to improve them.

Using the approach that involves the model 100 in developing the enterprise computing system can be significant from a solution—that is, from a customer—perspective. A faithful utilization of these principles will guarantee that the resulting system conforms with the established requirements. This is because the development process is in a sense made transparent to the KPI analysis. This is particularly relevant for the marketing or sales staff that are responsible for the system, because it makes the situation easier for them in helping the customer understand the benefits of the chosen solution.

FIG. 2 is a block diagram of a value of solution framework (VSF) 200 that organizes the information that is relevant to the return on investment analysis. For example, the value of solution framework 124 shown in FIG. 1 can include the VSF200. As such, the VSF200 compares a business value 128 with a cost of solution 130 to compute a value of solution (VS) 126. The business value may be reflected as both tangible and intangible values and is the motivation and the recoverable benefit of the enterprise computing system.

The cost of solution 130 indicates the particular cost of an implementation of an enterprise computing system. The cost of solution is the unavoidable expenses or efforts resulting from the use of the enterprise computing system to provide some benefit. Expenses or efforts captured by the cost of solution can arise throughout the entire development life-cycle of the enterprise computing system. As such, the VSF200 can be organized and evaluated during any or all phases of the enterprise computing system's development. Example efforts or expenses include, but are not limited to, an initial hardware or software investment, implementation efforts, maintenance costs, or continuous improvement costs. The cost of solution is measured using target characteristics for hardware and software investments 208, implementation 210, hardware and software ongoing costs 211, operational efforts and expenses 212, continuous improvement projects 214, upgrade projects 216, and end-user usage 218.

The hardware and software investment target characteristics 208 measure the initial investment in hardware and software required to support a functional enterprise computing system. In some implementations, the hardware and software target characteristics include a hardware platform, a network, an end user environment, application software, and system software or third party software.

The hardware platform measures the requirements of the hardware infrastructure needed to run the enterprise computing system. The hardware platform can include, but is not limited to, application servers, database and backup servers, and any additional storage units that may be required by the enterprise computing system.

The network measures the requirements of an average network needed to build up a communication infrastructure to facilitate communication by the enterprise computing system. An end user environment and a production environment are two example aspects of the enterprise computing system that may require a communication infrastructure.

The end user environment measures the requirements of the enterprise computing system needed by an end user to facilitate the execution of the implementation. The enterprise computing system can implement a graphical user interface or the ability to connect to multiple devices, to name two examples.

The application software measures an amount of required business software delivered to the customer for implementing some functionality in the enterprise computing system. In some implementations, the application software is delivered as a complete system or can be delivered as bundled functionality, e.g. a text editor application and a spreadsheet application could be bundled together to provide some necessary functionality.

The system software and third party software measures an amount of required system software, e.g. an operation system, or an amount of third party software, e.g. a compiler, required by the enterprise computing system to implement some predefined function.

The implementation target characteristics 2 1 0 measure the implementation process required to create a functional enterprise computing system. The implementation process can be measured from both a technical perspective and a business perspective. In some implementations, the implementation target characters can include planning, configuration, testing, training and project management.

Planning measures the effort required by the customer to supply a definition for the enterprise computing system. The customer can supply a conceptual definition or supply a prototype or simulation of the customer process, to name two examples.

Configuration measures the efforts required to create a specific characterization of an implementation of the enterprise computing system to meet a customer's needs. In some implementations, configuration tasks include, but are not limited to, process configuration, the definition of reports, the definition of forms, and user interface configurations.

Testing measures the efforts required to deliver a stable and reliably implemented enterprise computing system. Testing efforts include, but are not limited to, unit tests and integration tests, utilizing both black box and white box testing techniques.

Training measures the efforts required in providing the necessary training to the users of the enterprise computing system. Training can include, but is not limited to, delivery of manuals, in person training classes, and on-line training classes.

Project management measures the efforts required to coordinate the planning, configuration, testing, and training efforts of an implementation of the enterprise computing system.

The hardware and software ongoing costs target characteristic 211 measures the recurring technical costs associated with implementing and maintaining a functional enterprise computing system. Recurring costs can including, but are not limited to, support contracts, maintenance contracts, and licensing agreements. The operations target characteristics 212 measure the efforts required to ensure reliable operations of the enterprise computing system. In some implementations, the operations target characteristics can include system management, application management, and end user usage.

System management measures the efforts required by the technically focused tasks in order to maintain the enterprise computing system. System management efforts can include, but are not limited to, performing routine data back-ups and monitoring basic system functions.

Application management measures the efforts required by the business focused tasks in order to maintain the enterprise computing system, for example, monitoring a business process.

The continuous improvement projects target characteristics 214 measure the expenses and efforts associated with improvements to the enterprise computing system. In some implementations, the continuous improvement target characteristics can include continuous business improvement and continuous technical improvement.

Continuous business improvement measures efforts required to adapt the current enterprise computing system to changes in a business model or a business process. Adaptations can include, but are not limited to, optimizations of a business process, changes to products, partners, and customers, and changes in business models and underlying technology infrastructure. Continuous business improvement efforts can include, but are not limited to, modifications to existing functionality or enchantments to existing functionality with new functionality.

Continuous technical improvement measures the efforts required to keep the enterprise computer system technologically current. Continuous technical improvements, include, but are not limited to, upgrades to central processing units, adding additional memory, or consolidating various enterprise computing systems onto one platform.

The upgrade projects target characteristics 216 measure an initial cost associated with upgrading a system or set of systems so that the system or set of systems can execute the enterprise computing system. In some implementations, the upgrade projects target characteristics can include applications upgrades and system upgrades.

Application upgrades measure the cost associated with upgrading current applications. Applications can include, but are not limited to, operating systems, document authoring applications, and database applications.

System upgrades measure the cost associated with upgrading a current system architecture or a hardware platform. System upgrades can occur in a wholesale fashion, or the system upgrade target characteristic can be predetermined and executed in an iterative fashion.

The end user usage target characteristic 218 measures the efforts required by an end user to learn and efficiently use the enterprise computing system in the user's work. For example, these efforts may include learning the user interface components, the degree of satisfaction the end user derives from using the enterprise computing system, and the costs associated with productivity loss as the user learns the enterprise computing system.

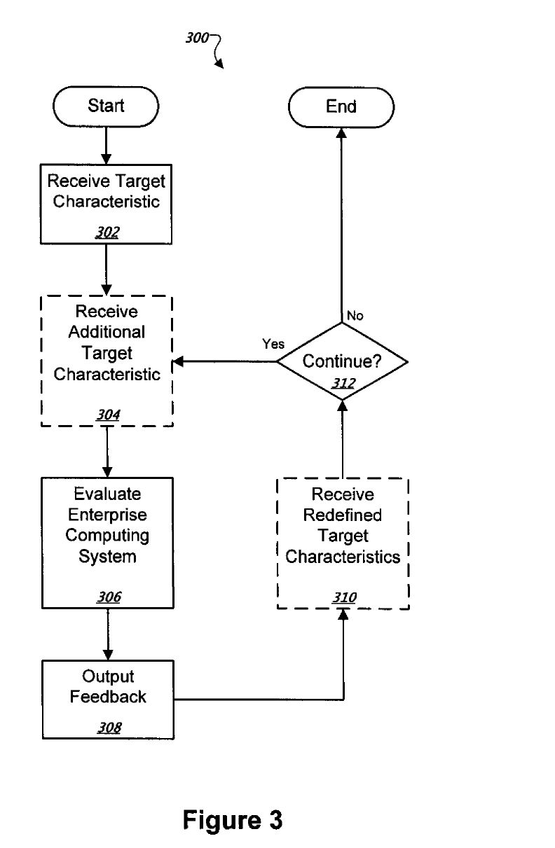

FIG. 3 shows a flow chart of an evaluation method 300 for a ROI analysis. The method receives a first target characteristic, as shown by step 302. The target characteristic is one that can later be used to also perform an ROI analysis of the implemented system. The method may also receive additional target characteristics, as shown by step 304. In some implementations, the target characteristics are organized in a value of solution framework, as described above in reference to FIG. 2.

The method can use the KPI framework derived from a value of solution framework to evaluate a predefined portion of the enterprise computing system, as shown by step 306. The KPI framework compares predetermined target characteristics against an implementation of the predefined portion of the enterprise computing system. In some implementations, the evaluation step 306 determines if the enterprise computing system meets a target characteristic or if the enterprise computing system meets or exceeds a target value for a KPI.

The method outputs the results of the evaluation, as shown in step 308, as feedback. The feedback can include to the degree to which the target characteristics are satisfied by the current predetermined portion of the enterprise computing system. If the feedback indicates non-conformance with the KPI, the feedback may trigger a revision of the development project.

Based on changes in requirements or product guidelines received from the customer, target characteristics may change over the course of development of the enterprise computing system. The method can receive a revised definition of the target characteristics, as shown by step 310. The revised target characteristics can also be organized into a value of solution framework, and can be passed back to the method for further evaluation, as shown by step 312.

The method can be executed any number of times and can evaluate any number of predefined portions of the enterprise computing system. The feedback generated by the execution of the method includes the results of the evaluation and can be used as a basis for improving the evaluated predefined portion of the enterprise computing system. The iterative nature of the evaluation of the method against predefine portions of the enterprise computing system can ensure that the enterprise computing system is in compliance with the specified target values at a time in which the enterprise computing system is delivered to the customer.

In some implementations, the method is embodied tangibly as a computer program that when executed performs the operations of receiving the target characteristics 302, receiving additional target characteristics 304, evaluating target characteristics against a predefined portion of the enterprise computing system 306, outputting feedback including the results of the evaluation 308, and receiving redefined target characteristics 310.

In some implementations, some or all steps of the method 300 can be repeated over time. Particularly, the method may be performed (at least once) for every project where a new system/solution is developed. Moreover, information from KPI evaluation in an earlier development can be stored and later used to improve the method when applied to a subsequent development project. For example, the information may be stored using an organization or structure that corresponds to the KPIs. This makes it convenient for participants in the later development to see how performance issues were handled, or what were the solution scenarios, to name a few examples.

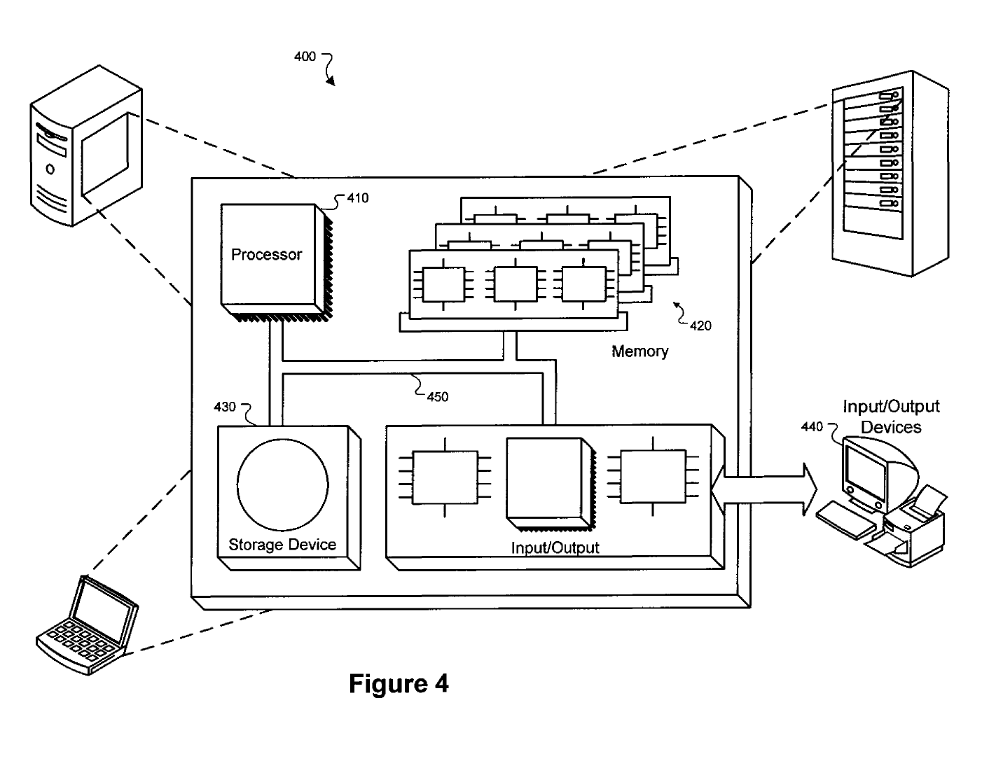

FIG. 4 is a block diagram of a computer system 400 that can be used in the operations described above, according to one embodiment.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one embodiment, the processor 410 is a single-threaded processor. In another embodiment, the processor 410 is a multi-threaded processor. The processor 410 is capable of processing instructions stored in the memory 420 or on the storage device 430 to display graphical information for a user interface on the input/output device 440.

The memory 420 stores information within the system 400. In one embodiment, the memory 420 is a computer-readable medium. In one embodiment, the memory 420 is a volatile memory unit. In another embodiment, the memory 420 is a non-volatile memory unit.

The storage device 430 is capable of providing mass storage for the system 400. In one embodiment, the storage device 430 is a computer-readable medium. In various different embodiments, the storage device 430 may be a floppy disk device, a hard disk device, an optical disk device, or a tape device.

The input/output device 440 provides input/output operations for the system 400. In one embodiment, the input/output device 440 includes a keyboard and/or pointing device. In one embodiment, the input/output device 440 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method of evaluating development of an enterprise computing system, the method comprising:
receiving, in a computer system, a definition of a target characteristic configured to be used in performing a return on investment analysis of an enterprise computing system;
during development of the enterprise computing system, evaluating at least a predefined portion of the enterprise computing system using the target characteristic; and
outputting from the computer system feedback information on the development including a result of the evaluation.

2. The method of claim 1, wherein the target characteristic is defined as a desirable value for a predefined aspect of the enterprise computing system.

3. The method of claim 1, wherein the target characteristic includes a target value associated with a key performance indicator, wherein the enterprise computing system is to be developed such that it meets the target value upon the key performance indicator being evaluated.

4. The method of claim 3, wherein at least one of the key performance indicator and the target value is defined based on market information.

5. The method of claim 3, further comprising identifying several processes included in installing and using the enterprise computing system, and analyzing the several processes to identify at least the key performance indicator.

6. The method of claim 3, wherein the key performance indicator is at least one indicator selected from the group consisting of: a required hardware investment, a required system compatibility, an average traffic volume, a required software investment, a time required for installation, a time required for technical configuration, a time required for installation training, a time required for implementation, an effort required for implementation, a skill set required for implementation, a number of employees needed for the enterprise computing system, a time required for training, an amount of downtime, an amount of work needed for an improvement or upgrade, an amount of training needed for an improvement or upgrade, an amount of downtime needed for an improvement or upgrade, an amount of work needed to detect a need for an improvement or upgrade, a time required to make an improvement or upgrade, an effort required to make an improvement or upgrade, a skill set required to make an improvement or upgrade, a standard compliance, a user efficiency, a user satisfaction, a user ease of learning, a number of solutions available for a specific problem, a number of modifications available, a test coverage, an error rate, and combinations thereof

7. The method of claim 1, wherein several target characteristics are received, the several target characteristics being organized in a value of solution framework that provides a basis for the return on investment analysis.

8. The method of claim 7, wherein the value of solution framework is configured for a total cost of ownership analysis to be performed based on at least one of the several target characteristics.

9. The method of claim 1, wherein several evaluations of the predefined portion of the enterprise computing system are performed over time during the development, and wherein feedback information is output for each of the evaluations.

10. The method of claim 1, wherein the predefined portion of the enterprise computing system that is evaluated is a prototype.

11. The method of claim 1, wherein the predefined portion of the enterprise computing system that is evaluated is a test case.

12. The method of claim 1, wherein the predefined portion of the enterprise computing system that is evaluated is a definition of a use case.

13. The method of claim 1, wherein the predefined portion of the enterprise computing system that is evaluated is a guideline for the enterprise computing system.

14. The method of claim 1, wherein the result of the evaluation states whether the predefined portion of the enterprise computing system meets the target characteristic.

15. The method of claim 1, wherein the result of the evaluation indicates a degree to which the predefined portion of the enterprise computing system conforms with the target characteristic.

16. The method of claim 1, further comprising:
receiving a revised definition of the target characteristic;
substituting the revised definition for the definition that was received earlier; evaluating the predefined portion of the enterprise computing system during the development using the revised definition of the target characteristic; and
outputting from the computer system feedback information on the development including a result of the evaluation that uses the revised definition.

17. The method of claim 1, further comprising storing at least a portion of the feedback information and later using the stored portion in development of another enterprise computing system.

18. The method of claim 17, wherein several target characteristics are used, and wherein the stored portion of the feedback information is structured according to a corresponding one of the several target characteristics.

19. A computer program product tangibly embodied in an information carrier, the computer program product including instructions that, when executed, cause a processor to perform operations comprising:
receiving, in a computer system, a definition of a target characteristic configured to be used in performing a return on investment analysis of an enterprise computing system;
during development of the enterprise computing system, evaluating at least a predefined portion of the enterprise computing system using the target characteristic; and
outputting from the computer system feedback information on the development including a result of the evaluation.

20. A computer program product tangibly embodied in an information carrier, the computer program product including instructions that, when executed, cause a processor to perform operations comprising:
receiving, in a computer system, several definitions of key performance indicators and corresponding target values, the key performance indicators and the target values being configured to be used in performing, for an enterprise computing system, a return on investment analysis that includes a total cost of ownership analysis;
during development of the enterprise computing system, performing evaluations of the enterprise computing system using the key performance indicators and the target values; and
outputting from the computer system feedback information on the development including results of the evaluations.

21. The computer program product of claim 20, wherein the feedback information indicates a degree to which the enterprise computing system conforms, at a point when the evaluations are performed, with the target values of the key performance indicators.

22. The computer program product of claim 20, wherein the operations further comprise:
receiving a revised definition of at least one of the key performance indicators or corresponding target values;
substituting the revised definition for the definition that was received earlier;
evaluating at least a portion of the enterprise computing system during the development using the revised definition; and
outputting from the computer system feedback information on the development including a result of the evaluation that uses the revised definition.
